(19) United States
(12) Patent Application Publication
(10) Pub. No.: US 2015/0090022 A1
(43) Pub. Date: Apr. 2, 2015

(54) METHOD AND DEVICE FOR CHECKING TIRE PRESSURE

(71) Applicant: Robert Bosch GmbH, Stuttgart (DE)

(72) Inventors: Volker Uffenkamp, Ludwigsburg (DE); Guenter Nobis, Nuertingen (DE)

(21) Appl. No.: 14/389,707

(22) PCT Filed: Mar. 19, 2013
(86) PCT No.: PCT/EP2013/055708

§ 371 Date: Sep. 30, 2014

(30) Foreign Application Priority Data
Apr. 4, 2012 (DE) 10 2012 205 495.2

(51) Int. Cl. B60C 23/08; G01M 17/02

(52) U.S. Cl. CPC B60C 23/08; G01M 17/022
USPC 73/146

(57) ABSTRACT

A method for monitoring the pressure in a tire of a rolling vehicle includes determining the length of the tire contact patch of the tire in the driving direction and inferring the pressure in the tire from the length of the tire contact patch.

### FIELD OF THE INVENTION

The present invention relates to a method and a device for checking the pressure in a tire of a vehicle, in particular of a rolling vehicle.

### BACKGROUND INFORMATION

The tire inflation pressure of a motor vehicle is very important for the safety in traffic, for the comfort and the driving behavior of the vehicle, for the fuel consumption, and for the tire wear. An inflation pressure which is not adapted to the stresses may significantly impair the directional and the driving stability and thus the safety of the vehicle, it may cause a noticeably increased fuel consumption, and result in a considerable shortening of the service life of the tires.

For this reason, the check of the tire inflation pressure is an integral part of the regular motor vehicle check-up service. The check-up service now takes place in very large time intervals. The tire inflation pressure should, however, be checked on a regular basis, approximately every 2 weeks, and additionally in the event of extraordinary stresses such as a long trip at a high velocity and/or heavy luggage.

The responsibility of checking the tire inflation pressure lies with the vehicle driver. Presently, a manual check of the tire inflation pressure is possible at gas stations and in repair shops, but it is cumbersome.

For these reasons, the check of the tire inflation pressure which is recommended by the tire manufacturers often takes place considerably less often or not at all. It would therefore be advantageous if the tire inflation pressure were to be checked automatically with the aid of a checking device when approaching a gas station.

Numerous methods are believed to be understood for checking the tire inflation pressure from the past decades.

In general, the methods may be divided into methods for directly checking the tire inflation pressure and methods for indirectly checking the tire inflation pressure, it being differentiated as to whether the check takes place in (a) standing or in (a) rolling vehicle or tires.

A method for checking the tire inflation pressure with the aid of a pressure measuring device which is to be adapted is to be assigned to the direct tire inflation pressure check in a standing vehicle and is known from FR 2 852 907 A3, for example. Moreover, methods for directly checking the tire inflation pressure are known which may be carried out in a standing as well as in a rolling vehicle. In the case of these methods, one or multiple sensors are provided at the valve (JP 3 141 838 U) or within the tire (DE 19 630 015 A1; US 2008/0133081 A1) which continuously monitor(s) the tire inflation pressure. If the tire inflation pressure exceeds or falls below predefined threshold values, a warning is displayed to the vehicle driver and/or a warning signal sounds. Sensors of this type are, however, often inaccurate and expensive.

Methods for indirectly checking the tire inflation pressure in a rolling vehicle are discussed in EP 656 269 A1, EP 695 935 A1, and WO 2008/034411 A1 in which the tires of the vehicle roll over a force sensor matrix.

The tire inflation pressure may be derived from the tire contact patch (contact patch) and the contact force of the individual force sensors within the tire contact patch or from the differences of the measured contact force between the individual force sensors, i.e., from the characteristic differences in the pressure distribution within the tire contact patch.

However, force sensor matrices are, on the one hand, expensive since the sensors must be situated across a sufficiently large area. On the other hand, they are susceptible to destruction and erroneous measurements if they are configured as pressure-sensitive measuring films since they are subjected to mechanical transversal stresses when being rolled over due to startup and braking actions as well as due to wheel camber and toe-in of the wheel axle.

Other methods for indirectly checking the tire inflation pressure in a rolling vehicle use, instead of a force sensor matrix, a row configuration of force sensors for detecting the pressure distribution in the tire contact patch. The row is dimensioned in such a way that the width of the tire contact patch (patch width) may be detected. The length of the tire contact patch (patch length) which is also necessary for ascertaining the tire contact patch additionally requires the determination of the velocity of the motor vehicle. In U.S. Pat. No. 5,396,817, the velocity is determined from the rise and drop of the signal which is generated while the tire is rolling across the force sensor row. In EP 892 259 A1, a contact rail is situated in front of the force sensor row in the driving direction in order to ascertain the driving velocity in interaction with the force sensor row.

The above-described methods using force sensor matrices and force sensor rows have not been applied on a wide range so far, since the systems are very complex and require a complex electronic evaluation and arithmetic unit due to the large amount of data.

A method for indirectly checking the tire inflation pressure in a rolling vehicle by using individual force sensors is discussed in WO 1998/052008 A1. In this method, the wheel rolls across two piezoelectric sensor wires having a known distance from one another. Piezoelectric sensors generate a voltage due to a force which acts on them. The wave shape of the voltage signal during the crossing has a characteristic which is a function of the tire air pressure and which is in addition a function of the wheel load of the motor vehicle and of the velocity of the crossing. The method provides that the velocity is determined from the known distance between the two sensor wires, that the wheel load is estimated from the amplitude of the voltage signal, and that appropriate corrections are applied which are stored in a database.

Furthermore, the optical detection of the tire contact patch is also believed to be understood.

Patent document DE 197 05 047 A1 discusses a method for measuring the profile depth of a tire in which the tire profile is acted on by laser light.

Patent document US 2009/0290757 discusses a method in which a three-dimensional profile of an object is generated from the image data of an object and the three-dimensional profile of the object is analyzed for the purpose of detecting anomalies of the object.

In the method discussed in EP 1 305 590 A1, a tire rolls across a glass plate and a camera below the glass plate records images of the tire. Due to wear, contamination, and the risk of damage to the glass plate, this system is not particularly well suited for use in a rough traffic environment, but rather reserved for laboratory operation.

Thus, the need still exists for a robust method for indirectly checking the tire inflation pressure in a rolling vehicle, which may be carried out easily and cost-effectively, as well as for a device which is configured to carry out a method of this type.

### SUMMARY OF THE INVENTION

A method according to the present invention for monitoring the pressure in a tire of a rolling vehicle includes determining the length of the tire contact patch of the tire in the driving direction and inferring the pressure in the tire from the length of the tire contact patch, and, in particular, establishing whether the pressure is within a predefined range.

A device according to the present invention for monitoring the pressure in a tire of a vehicle which is rolling across a roadway plane has at least two sensors which are spaced apart from one another in the rolling direction of the tire and which are suitable to detect a contact of the tire with the roadway plane and to output a corresponding signal, as well as an evaluation unit which is configured to determine the length of the tire contact patch of the tire in the driving direction from the time intervals of the sensor signals and thus to infer the pressure in the tire from the length of the tire contact patch determined in this way.

The method and the device are suited to carry out a check of the tire inflation pressure in areas having low driving velocities of motor vehicles, such as in driveways to gas stations, repair shops or parking lots, and to immediately output a corresponding message to the driver in the form of a multi-colored signal light, for example. With the measurement at a rolling vehicle or tire, the present invention provides a widely usable approach which is also comfortable for the driver.

The present invention provides a cost-effective and robust approach which may also be used under rough checking conditions. A device according to the present invention may be installed in the roadway or in a shallow bump which is situated on the roadway.

The present invention has a sufficiently high accuracy for indirectly checking the tire inflation pressure at a rolling vehicle.

The accuracy of the measurement may be increased by at least one additional time measurement, which results in an overdetermination, and the measurement may be corrected or invalidated in the case of a lack of consistency of the crossing speed due to a braking action or an acceleration.

In one specific embodiment, the method includes the determination of whether the pressure in the tire is within a predefined range. Tires having an excessively low tire inflation pressure (safety-relevant!) are very likely to be detected in this way.

In one specific embodiment, the method includes determining the pressure in the tire from the length of the tire contact patch. The pressure in the tire may thus be determined easily and comfortably for the driver.

In one specific embodiment, the method includes determining the length of the tire contact patch from time differences between the crossing of at least two sensors which are situated in series in the driving direction. The length of the tire contact patch may thus be determined reliably and with a sufficiently high accuracy.

In one specific embodiment, the sensors are configured as contact switches. Contact switches provide cost-effective and robust sensors which are also suitable for rough checking conditions. The contact switches may be mechanical contact switches, but are not limited thereto.

In one specific embodiment, the time intervals include the time difference between the first and the last contacts of the tire contact patch with a first sensor.

In one specific embodiment, the time intervals include the time difference between the first contact of the tire contact patch with a first sensor and the first contact of the tire contact patch with a second sensor which is situated behind the first sensor in the driving direction.

In one specific embodiment, the time intervals include the time difference between the last contact of the tire contact patch with a first sensor and the last contact of the tire contact patch with a second sensor which is situated behind the first sensor in the driving direction. The length of the tire contact patch of the tire may be determined reliably and with sufficient accuracy with the aid of time difference determinations of this type.

In one specific embodiment, the method includes comparing the tire contact patches of at least two tires to one another, in particular of tires which are mounted on one shared axle. This allows for the equality of the tire inflation pressure of multiple tires, in particular of multiple tires which are mounted on one shared axle, to be checked and for the reliability of the measurement to be increased.

A method for indirectly checking the tire inflation pressure at a vehicle axle includes, for example, the following method steps:

1. Measuring the time at the first sensor by rolling across with the tire (on both sides of the vehicle using one measuring system in each case).
2. Measuring the time at the second sensor by rolling across with the tire (on both sides of the vehicle using one measuring system in each case).
3. Determining the length of the tire contact patch for each tire from the time difference of the crossing over the two sensors, which are spaced apart at a known distance. The formula implicitly includes the velocity of the motor vehicle.
4. Checking the validity of the measurement for each tire, correcting the length of the tire contact patch, if necessary, or cancelling the check of the tire inflation pressure and outputting “erroneous measurement.”
5. Determining the relative difference between the measured lengths of the tire contact patches of the tires which are mounted on one axle of the vehicle and comparing it with a predefined limiting value.
5a. If the computed difference is smaller than or equal to the limiting value, the result is okay.
5b. If the computed difference is greater than the limiting value, then the tire having the longer tire contact patch is assigned to the state category “check tire inflation pressure—increased fuel consumption: signal light color Yellow.”
6. Assigning each tire of the vehicle axle to a state category with the aid of a classifier based on the measured length of the tire contact patch and assessing the tire inflation pressure of each individual tire.
6a. If the tire was already assigned to the state category “check tire inflation pressure—increased fuel consumption: signal light color Yellow” based on the difference between the lengths of the tire contact patches of the tires which are mounted on one axle, this state category is overwritten only if the classifier identifies the state category “increase tire inflation pressure—safety hazard: signal light color Red” for this tire.
7. Visually displaying the check results of each tire to the driver, e.g., indicating the state category in plain text and/or using a signal light color (red-yellow-green) which is coupled to the state category.
8. If necessary, transmitting the measuring data and results to a server (optional).

The method steps for a two-axle vehicle include method steps 1 through 6 described above for the front axle and immediately afterwards, the same method steps 1 through 6 for the rear axle. Method steps 7 and 8 are carried out simultaneously for all tires of a vehicle.

In another specific embodiment, the method includes determining the profile depth of the tire and taking into consideration the length of the tire contact patch for the computation. A method for indirectly checking the tire inflation pressure includes in an upgraded variant the following method steps, taking into consideration the profile depth of the tire:

1. Measuring the time at the first sensor by rolling across with the tire (on both sides of the vehicle using one measuring system in each case).
2. Measuring the time at the second sensor by rolling across with the tire (on both sides of the vehicle using one measuring system in each case).
3. Measuring the profile depth while rolling across with the tire (on both sides of the vehicle using one measuring system in each case).
4. Determining the length of the tire contact patch for each tire from the time differences of the crossing over both sensors, which are spaced apart at a known distance. The formula implicitly includes the velocity of the motor vehicle.
5. Checking the validity of the measurement for each tire, correcting the length of the tire contact patch, if necessary, or cancelling the check of the tire inflation pressure and outputting “erroneous measurement.”
6. Computing the profile-depth corrected length of the tire contact patch for each tire using the measured profile depth.
7. Determining the relative difference between the profile-depth corrected lengths of the tire contact patches of the tires which are mounted on one axle and comparing it with a predefined limiting value.
7a. If the computed difference is smaller than or equal to a predefined limiting value, the result is okay.
7b. If the computed difference is greater than the predefined limiting value, the tire having the longer tire contact patch is assigned to the state category “check tire inflation pressure—increased fuel consumption: signal light color Yellow”.
8. Assigning each tire of the vehicle axle to a state category with the aid of a classifier based on the profile-depth corrected length of the tire contact patch of the tire and thus assessing the tire inflation pressure of each individual tire.
8a. If the tire was already assigned to the state category “check tire inflation pressure—increased fuel consumption: signal light color Yellow” based on the difference between the lengths of the tire contact patches of the tires which are mounted on one axle, this state category is overwritten only if the classifier identifies the state category “increase tire inflation pressure—safety hazard: signal light color Red” for this tire.
9. Visually displaying the check results of each tire to the driver, e.g., indicating the state category in plain text and/or using the signal light color (red-yellow-green) which is coupled to the state category.
10. If necessary, transmitting the measuring data and results to a server (optional).

The method steps for a two-axle vehicle include method steps 1 through 8 described above for the front axle and immediately afterwards, the same method steps 1 through 8 for the rear axle. Method steps 9 and 10 are carried out simultaneously for all tires of the vehicle.

In addition, the profile depth and/or a signal light color which is coupled to the assessment of the profile depth may also be displayed for each tire. For this purpose, the assessment of the profile depth takes place using the statutory predefined minimum profile depth and a defined value for the warning of strongly worn tires which have only a short service life left. If the measured profile depth falls below a predefined warning value, the signal light color “Yellow” is displayed, if it falls below the minimum profile depth, the signal light color “red” is displayed, and otherwise, the signal light color “Green” is displayed.

The present invention is explained in greater detail below on the basis of the attached figures.’

### BRIEF DESCRIPTION OF THE DRAWINGS

FIG. 1 shows in a schematic representation the correlation between the time measurement of a rolling tire and the length of its tire contact patch.

FIG. 2 shows in a schematic representation one exemplary embodiment of a device for checking the tire inflation pressure.

FIG. 3 shows one exemplary embodiment of a crossing groove having an integrated checking system.

FIG. 4 shows a checking cover of a crossing groove in the top view.

FIG. 5 shows, as an example, the correlation between the length of the tire contact patch and the tire inflation pressure.

FIG. 6 shows characteristic curves of the tire inflation pressure as a function of the length of the tire contact patch for different vehicles of different vehicle categories having different tires.

FIG. 7 shows state categories for the tire inflation pressure.

FIG. 8 describes a classifier for the tire inflation pressure having four state categories.

FIG. 9 shows characteristic curves of the tire inflation pressure as a function of the length of the tire contact patch for a partially loaded and a fully loaded vehicle.

FIG. 10 shows the correlation between the length of the tire contact patch and the tire inflation pressure for two different tire types.

### DETAILED DESCRIPTION

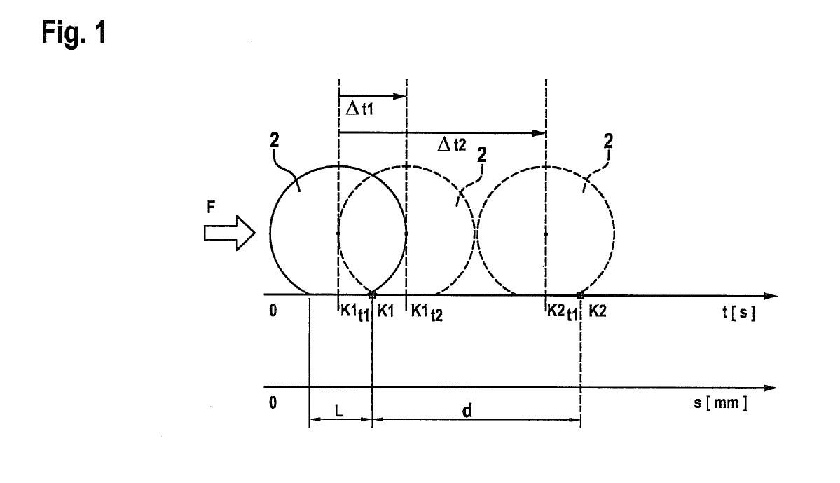

FIG. 1 shows in a schematic representation the correlation between the time measurement of a rolling tire 2 and length L of its tire contact patch, illustrated tire 2 rolling along driving direction F from left to right over a first contact switch or sensor K1 and a second contact switch or sensor K2. Contact switches K1 and K2 are spaced apart from one another at a known distance d in the rolling direction of tire 2.

The first and the second contacts of the tire contact patch with first contact switch K1 are identified by K1ₜ₁ and K1ₜ₂, respectively, and the first contact of the tire contact patch with second contact switch K2 is identified by K2ₜ₁.

Length L of the tire contact patch is obtained by multiplying the quotient of the time differences by known distance d between the two contact switches K1, K2:

L=d*(K1ₜ₂−K1ₜ₁/(K2ₜ₁−K1ₜ₁)=d*Δt1/Δt2 (1)

Formula (1) implicitly also includes the determination of the driving velocity of the vehicle.

In addition, at least one other (fourth) time measurement K2ₜ₂ may be carried out by second contact switch K2 at the last contact of the tire contact patch and used for the evaluation. Optionally, other contact switches, which are not shown in

FIG. 1, may be additionally provided to allow for additional time measurements.

A fourth time measurement K2ₜ₂ and, if necessary, other time measurements result in an overdetermination which makes it possible to increase the accuracy of the measurement and to correct the results by detecting possible velocity changes due to acceleration or braking during the crossing and taking them into consideration, for example.

In addition, the measurement in conjunction with a corresponding notification to the driver may be invalidated if the velocity changes during the crossing exceed a predefined limiting value, thus making a reasonable correction and evaluation no longer possible.

The computation of length L of the tire contact patch according to formula (1) also applies when distance d between the two contact switches K1, K2 is shorter than length L of the tire contact patch, i.e., when second contact switch K2 is already reached by the tire contact patch before the tire contact patch has left first contact switch K1 (K2ₜ₁<K1ₜ₂).

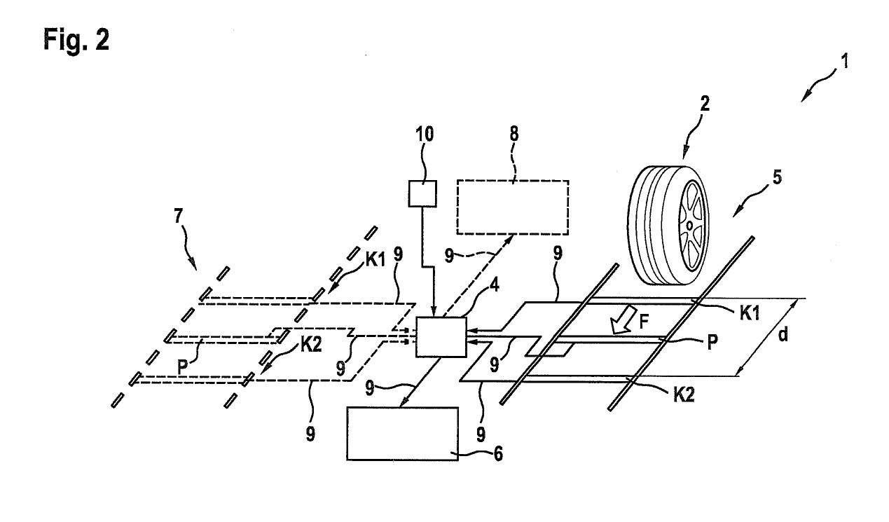

FIG. 2 shows, as an example, one exemplary embodiment of a checking device 1 for checking the tire inflation pressure including two systems 5, 7, each of which has at least two contact switches K1, K2 which are situated in or on a roadway transversely to driving direction F of a vehicle which is not illustrated in FIG. 2.

A complete checking device 1 includes at least two systems 5, 7, one for each side of the vehicle. The two contact switches K1, K2 of a system 5, 7 are connected via electrical connecting wires 9 or wirelessly to a shared measuring and evaluation unit 4. Measuring and evaluation unit 4 is connected via suitable electrical connecting wires 9 or wirelessly to a display unit 6 and optionally to a server 8.

Distance d between the two contact switches K1, K2 of the two systems 5, 7 in driving direction F is known to measuring and evaluation unit 4. Measuring and evaluation unit 4 is implemented between the actuations of the two contact switches K1, K2 of each system 5, 7 for the purpose of precisely measuring and storing the time intervals.

In driving direction F, an attachment P for measuring the profile depth of tire 2 is situated in each case between the two contact switches K1, K2 of each system 5, 7. Attachment P for measuring the profile depth is optional and not absolutely necessary for implementing the method according to the present invention for determining the tire inflation pressure. The use of the results of a measurement of the profile depth for the purpose of improving the measurement results for the tire inflation pressure is described further below.

Measuring and evaluation unit 4 is equipped with an arithmetic unit, a memory, and an evaluation software and carries out a check for plausibility of the measurement results, a computation of the vehicle velocity, and length L of the tire contact patch of each tire 2, as well as a classification of tire inflation pressure p into predefined state categories. Measuring and evaluation unit 4 also controls display unit 6 to output the check results as well as, if necessary, the transmission of the measurement and check results to a superordinate server 8.

The measurement accuracy with which length L of the tire contact patch may be determined is defined by distance d between the two contact switches K1, K2, the tolerance of distance d, and the accuracy of the time measurement. To be able to achieve a sufficiently high measurement accuracy, while keeping the complexity reasonable from the manufacturing standpoint, distance d between the two contact switches K1, K2 should be at least 200 mm.

In order to prevent erroneous measurements due to accidental triggering of contact switches K1, K2 caused by people walking over contact switches K1, K2, for example, measuring and evaluation unit 4 may be equipped with a plausibility algorithm which unambiguously differentiates between a person and a vehicle based on the time sequence of the time measurements of all contact switches K1, K2 of checking device 1 and excludes erroneous results.

Checking device 1 described above may be expanded by an additional sensor 10 which is configured as a contact switch, for example. This sensor 10 must be suited to detect a vehicle which is approaching checking device 1. Additional sensor 10 is connected to measuring and evaluation unit 4 and the latter triggers a restart of the measuring algorithm upon receipt of the signal from sensor 10 and shortly before a vehicle travels over checking device 1.

During the check, the vehicle first drives with its front tires 2 over checking device 1 and then with its rear tires 2. In this way, lengths L of the tire contact patches of all tires 2 of a vehicle may be determined almost simultaneously with the aid of a checking device 1.

Checking device 1 may be advantageously integrated into a crossing groove 12, such as the one known from and proven in road construction.

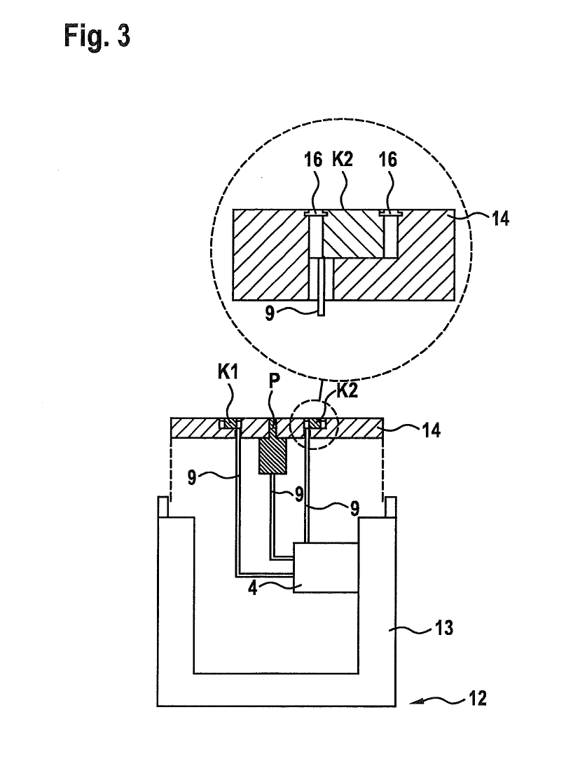

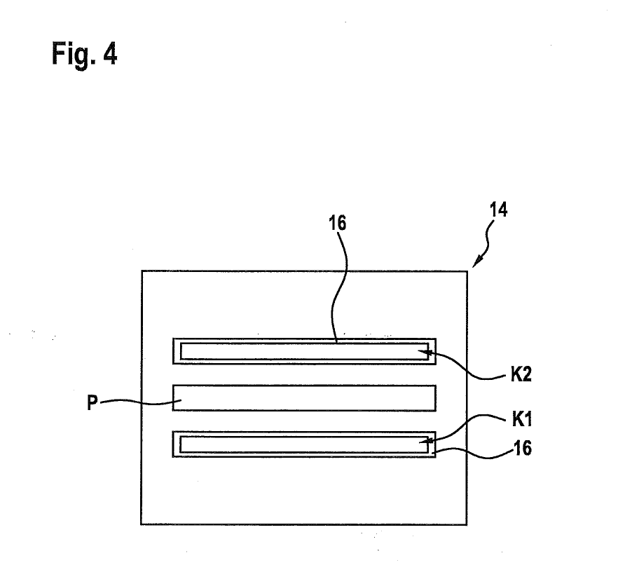

FIG. 3 shows one exemplary embodiment including such a crossing groove 12 in a cross section, and FIG. 4 shows a special checking cover 14 of crossing groove 12 in the top view having a system of two contact switches K1, K2 integrated therein for measuring lengths L of the tire contact patches of tires 2 which are mounted on one side of the vehicle.

In the driving direction, an attachment P for measuring the profile depth of tire 2 is situated between the two contact switches K1, K2.

Contact switches K1, K2 are each mounted in one recess of cover 14 of crossing groove 12, so that, depending on the specific embodiment of the switching element, its surface sits flush with the top edge of cover 14 and thus the roadway plane, if necessary, only after the switching path has been completed.

The gap between cover 14 and contact switches K1, K2 is circumferentially filled with a suitable elastomer 16 having a sufficient layer thickness in order to permanently prevent wetness, dust and dirt from penetrating. It is advantageous to provide a form fit between a recess in cover 14 and elastomer 16 as well as between elastomer 16 and contact switches K1, K2. For this purpose, cover 14 and contact switches K1, K2 may be configured to have an appropriate shaping such as a groove or rills.

The physical properties and the layer thickness of elastomer 16 are selected in such a way that the triggering force of contact switches K1, K2 is small enough to ensure a reliable triggering of contact switches K1, K2 even in the case of light vehicles which have a small wheel load.

The physical properties of elastomer 16 may also be taken into consideration in the algorithm for determining length L of the tire contact patch by using a correction element.

Every recess in cover 16 is provided with a through-hole (e.g., a bore) to the bottom side of cover 16 for the purpose of conducting electrical connecting wires 9 from contact switches K1, K2 to measuring and evaluation unit 4. Measuring and evaluation unit 4 may also be integrated into crossing groove 12. Mounting on a side wall 13 of crossing groove 12, as shown in FIG. 3, protects measuring and evaluation unit 4 against tail water, for example, which accumulates at the bottom of crossing groove 12.

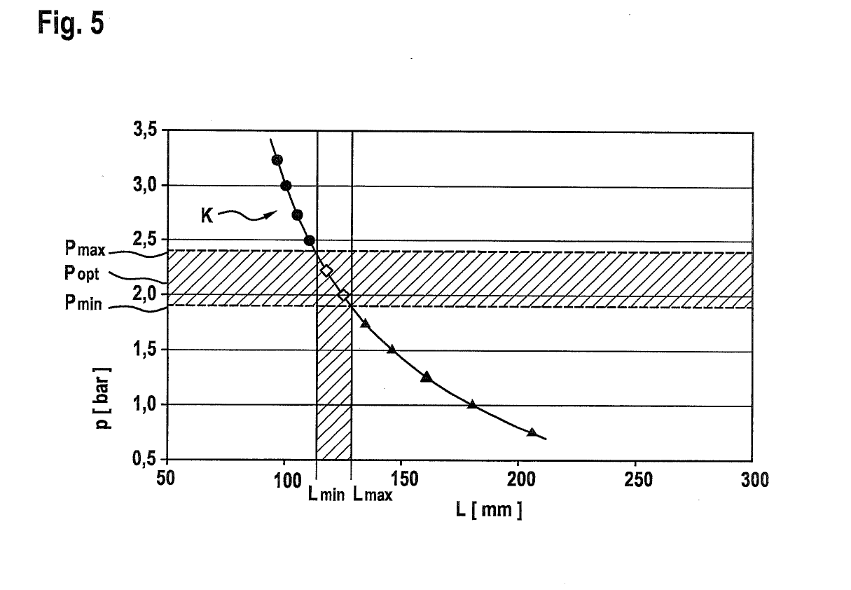

FIG. 5 shows, as an example, the correlation between length L of the tire contact patch and tire inflation pressure p for a specific vehicle. For every vehicle, an optimum tire inflation pressure pₒₚₜ is established between the tire and the vehicle manufacturers, 2.1 bar in the example shown here.

The following may be derived from the technical information of the tire manufacturers:

If optimum tire inflation pressure pₒₚₜ is fallen below by no more than 10% or exceeded by no more than 15%, an increased fuel consumption of less than 1% and a tire service life of more than 95% are to be expected.

If, however, tire inflation pressure p has greater deviations from optimum value pₒₚₜ, the consequences are a disproportionately greater increased fuel consumption and/or a disproportionately shorter service life.

For this reason, horizontal boundary curves Pₘᵢₙ, pₘₐₓ are indicated in FIG. 5 for a state “tire inflation pressure O.K.” at a distance of +15% and −10% from optimum value pₒₚₜ.

A first option for checking tire inflation pressure p from measured length L of the tire contact patch may be derived from FIG. 5. Limiting values Lₘᵢₙ, Lₘₐₓ for length L of the tire contact patch directly result for the state “tire inflation pressure O.K.” from the curves of charted pressure limiting values pₘᵢₙ, pₘₐₓ which intersect with ascertained tire characteristic curve K. In this way, it is possible to directly derive a check of tire inflation pressure p from the measurement of length L of the tire contact patch. Shorter lengths L of the tire contact patch (L<Lₘᵢₙ) indicate the state “tire inflation pressure too high” and longer lengths L of the tire contact patch (L>Lₘₐₓ) indicate the “tire inflation pressure too low” state.

In the case of exact knowledge of tire characteristic curve K, tire inflation pressure p may even be directly inferred from length L of the tire contact patch. The prerequisite here is, however, that for the checked vehicle, the dimensions and the type of tires 2, and tire characteristic curve(s) K associated with these tires 2 are known from a database, for example, for the correlation between length L of the tire contact patch and tire inflation pressure p. In practice, this will only occur in exceptional cases.

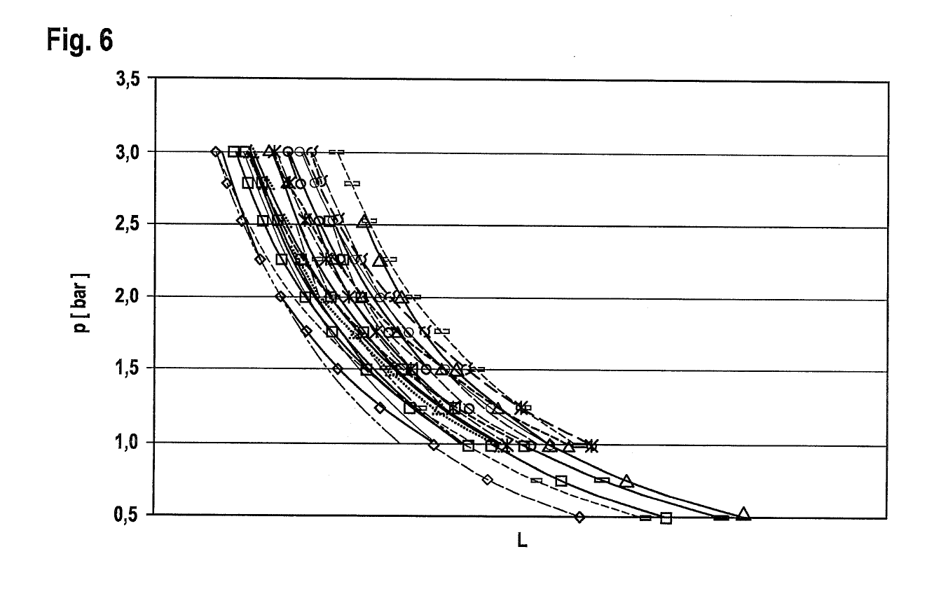

FIG. 6 shows multiple characteristic curves of the tire inflation pressure as a function of length L of the tire contact patch for different vehicles of different vehicle categories having different tires. It is recognizable that the characteristic curves strongly deviate from one another. The characteristic curves extend in a wide band and some of them intersect, but they still have a general, shared system. However, a direct assessment of tire inflation pressure p from length L of the tire contact patch does not seem to be trivial.

It is described in the following how a generally applicable checking method may be derived from the group of characteristic curves illustrated in FIG. 6.

For this purpose, as shown in FIG. 5 for an individual tire 2, it is analyzed for every point of characteristic curve K of each tire 2 which tire inflation pressure state is present. Here, it is differentiated between the three states “tire inflation pressure too high,” “tire inflation pressure too low,” and tire inflation pressure O.K.”

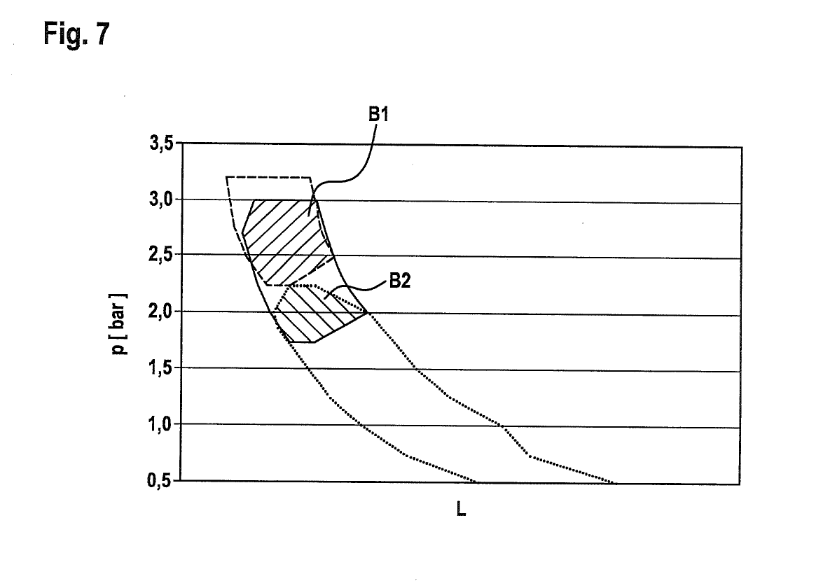

FIG. 7 shows the result of the analysis for the three state categories “tire inflation pressure too high,” “tire inflation pressure O.K.,” and “tire inflation pressure too low” for tire inflation pressure p. In FIG. 7, only the boundary curves of each tire inflation pressure state are plotted for the sake of clarity.

It is apparent from FIG. 7 that there is a large first intersection area B1 between the states “tire inflation pressure too high” (dashed boundary curve) and “tire inflation pressure O.K.” (solid boundary curve). Second intersection area B2 between the states “tire inflation pressure O.K.” (solid boundary curve) and “tire inflation pressure too low” (dotted boundary curve) is smaller.

Now, a state classifier is determined for tire inflation pressure p based on measured length L of the tire contact patch using known mathematical optimization processes. In this case, it is possible to continue using the three state categories described previously; alternatively, a larger number of state categories may also be defined, each of which is connected to a clear recommendation for action for the driver.

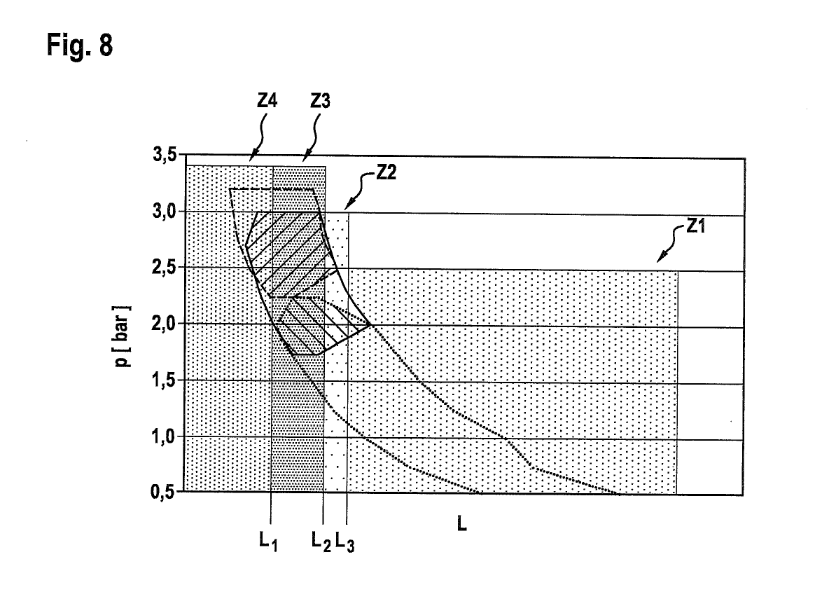

As an example, a classifier having the following four state categories is now described in conjunction with FIG. 8:

Z1: pressure too low, safety hazard: signal light color Red, increase tire inflation pressure!
Z2: test—low, increased fuel consumption: signal light color Yellow, check tire inflation pressure!
Z3: pressure O.K., tire inflation pressure is okay: signal light color Green
Z4: pressure too high, increased wear: signal light color Yellow, check tire inflation pressure!

State boundaries L₁, L₂, and L₃ of the four state categories Z1, Z2, Z3, and Z4 are computed with the aid of the optimization criterion of what may be a low erroneous classification rate. These state boundaries L₁, L₂, and L₃ are plotted in FIG. 8 as perpendicular curves L₁, L₂, and L₃. This classifier is used to assign each measured length L of the tire contact patch directly to one of the four state categories Z1, Z2, Z3, and Z4 with the aid of a simple algorithm.

Another checking criterion for tire inflation pressure p represents the demand of the tire and vehicle manufacturers that inflation pressures p of all tires 2 of one axle must be identical, whereas inflation pressures p of tires 2 may, indeed, differ between the front and the rear axles. Since tires 2 of the same type are always mounted on one axle, an additional option for checking deviations in tire inflation pressure p relatively accurately between the left and the right tire 2 of one axle results when measuring length L of the tire contact patch.

In the case of such a relative check, there is no need for exact knowledge of characteristic curve K which describes the relationship between length L of the tire contact patch and tire inflation pressure p. Difference ΔL between lengths L of the two tire contact patches of tires 2, which are mounted on one axle, may not exceed a defined limiting value of x % of the smaller of the two values. Alternatively, this limiting value may also refer to the greater of the two values or to their mean value.

Difference ΔL of lengths L of the tire contact patches between the left and the right tire 2 should not be greater than 6%, taking into consideration the previous explanation on how to derive boundary curves Lₘᵢₙ, Lₘₐₓ for “tire inflation pressure O.K.” in FIG. 5 and observing the results from very different tires 2 in FIG. 7.

The following results were obtained for an assessment of an individual tire from the studies using a 4-stage classifier:

Z1: increase tire inflation pressure, safety hazard: signal light color Red
approximately 80% correct detection rate
Z2: check tire inflation pressure, increased fuel consumption: signal light color Yellow
approximately 30% correct detection rate
Z3: tire inflation pressure O.K.: signal light color Green
approximately 60% correct detection rate
Z4: check tire inflation pressure, increased wear: signal light color Yellow
approximately 60% correct detection rate

This results in a sufficiently high detection rate or low erroneous classification rate for state category Z1 which is particularly relevant for safety. The relatively high erroneous classification rates in the case of other state categories Z2, Z3, and Z4 may still be significantly reduced in practice with the aid of an additional assessment per axle of difference ΔL of lengths L of the tire contact patches.

In FIG. 5, the characteristic curve for tire inflation pressure p and length L of the tire contact patch is illustrated for a specific tire 2 including the boundaries for “tire inflation pressure O.K.” and corresponding lengths L of the tire contact patch.

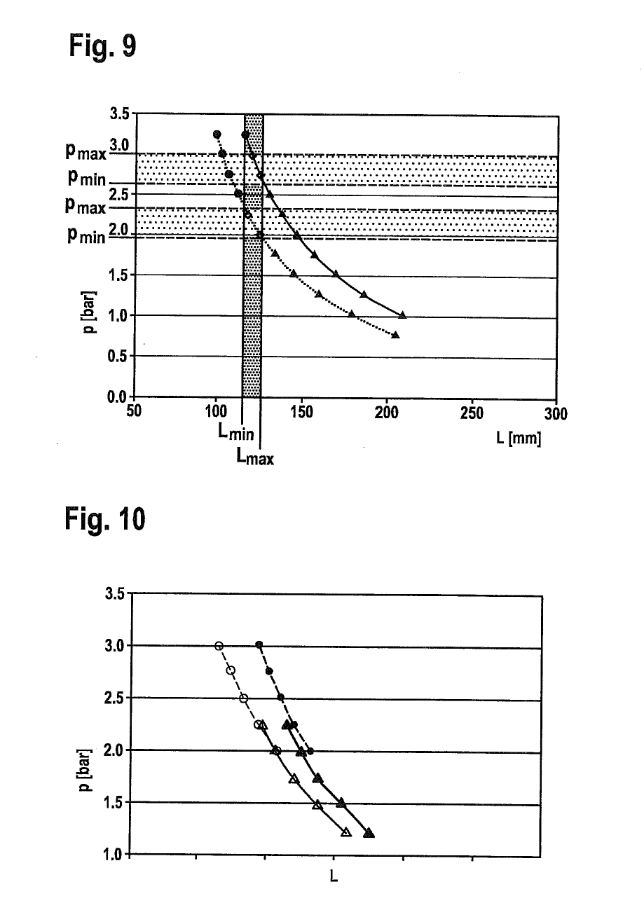

FIG. 9 shows the characteristic curves for a partially loaded and a fully loaded vehicle including the corresponding horizontal boundary curves for “tire inflation pressure O.K.” for the two above-mentioned loading states in one joint diagram.

It is well recognizable from the representation in FIG. 9 that the vehicle manufacturers try to achieve a constant length L of the tire contact patch, independently of the loading state, by establishing tire inflation pressure p for different loading states. It is to be therefore assumed that there is a high correlation between length L of the tire contact patch and the physical tire properties which are important for driving safety and driving comfort. This fact supports and facilitates the method according to the present invention for assessing tire inflation pressure p based on measured length L of the tire contact patch.

In further studies on different tire types and tire dimensions, the influence of the profile depth on length L of the tire contact patch was studied for different tire filling pressures p.

It is to be established that length L of the tire contact patch is reduced with increasing tire wear, i.e., with decreasing profile depth, while tire inflation pressure p and the wheel load remain the same.

FIG. 10 shows the correlations between length L of the tire contact patch and tire inflation pressure p for two different tire types, a standard tire (solid curve) and a run-flat tire (dashed curve) at a wheel load which is constant for each of the tire types, but is different for the two tire types as is typical for the tires and at different wear states in each case (new tires and tires with maximally admissible tire wear or minimally admissible profile depth).

It is recognizable from FIG. 10 that tires 2 have a smaller length L of the tire contact patch with increasing tire wear (left curves, open symbols) than in their new condition (right curves, filled-in symbols) under otherwise identical conditions. This means that the accuracy of the indirect method according to the present invention for checking the tire inflation pressure may be significantly improved if combined with an additional profile depth measurement.

A checking method expanded in this way includes an additional measurement of the profile depth of each tire 2 as compared to the previously described method.

For this purpose, attachment P, which has already been mentioned and which is shown in FIGS. 2 through 4, is used to measure the profile depth. As additional steps, the profile depth of tire 2 is measured with the aid of attachment P and a correction of measured length L of the tire contact patch is carried out based on the measured profile depth.

For all studied summer tires, wheel loads and tire pressures, a change in length L of the tire contact patch of 1.6 mm was ascertained in each case per mm tire wear. Profile-depth corrected length L of tire contact patch L_{RK} may therefore be computed as follows:

L_{RK}=L_{R}+(Tₘₐₓ−T_{R})*1.6 (2)

where:
L_{R} is the measured length of the tire contact patch as previously described,
Tₘₐₓ is the (maximum) profile depth of a new tire,
TR is the instantaneously measured profile depth.

For winter tires, other values may be used for the change in length L_{R} of the tire contact patch as a function of the profile depth (here: factor 1.6) and for maximum profile depth Tₘₐₓ.

Subsequently, the method is continued as described previously, corrected length L_{RK} of the tire contact patch being used instead of measured length L_{R} of the tire contact patch for the purpose of assessing tire inflation pressure p with the aid of the previously described state classifier in the sense of a diagnosis.

A change of the previously described state classifier is not necessary for the above-described expansion of the method by a profile depth measurement.

1-10. (canceled)

11. A method for checking a pressure in a tire of a rolling vehicle, the method comprising:
determining a length of a tire contact patch of the tire in a driving direction; and
inferring the pressure in the tire from the length of the tire contact patch.

12. The method of claim 11, wherein the method includes determining whether the pressure in the tire is within a predefined range.

13. The method of claim 11, wherein the length of the tire contact patch is determined from at least one time difference between the crossing over at least two sensors which are situated in series in the driving direction.

14. The method of claim 13, wherein the time differences include the time difference between a first contact and a last contact of the tire contact patch with the first sensor.

15. The method of claim 13, wherein the time differences include the time difference between the first contact of the tire contact patch with the first sensor and the first contact of the tire contact patch with the second sensor and/or the time difference between the last contact of the tire contact patch with the first sensor and the last contact of the tire contact patch with the second sensor.

16. The method of claim 11, further comprising:
comparing the lengths of the tire contact patches of at least two tires to one another.

17. The method of claim 16, further comprising:
determining a profile depth of the tire and taking into consideration the length of the tire contact patch for the computation.

18. A device for checking a pressure in a tire of a vehicle which is rolling over a roadway plane, comprising:
at least two sensors which are spaced apart from one another in the rolling direction of the tire and which are suitable to detect a contact of the tire with the roadway plane, and
an evaluation unit to determine the length of the tire contact patch of the tire in the driving direction from the time intervals of the sensor signals, and to infer the pressure in the tire from the length of the tire contact patch.

19. The device of claim 18, wherein the sensors are spaced apart from one another at a known distance in the rolling direction of the tire.

20. The device of claim 19, further comprising:
an attachment to determine the profile depth of the tire.

21. The method of claim 11, further comprising:
comparing the lengths of the tire contact patches of at least two tires to one another, wherein the at least two tires which are mounted on a same axle of the vehicle.
